(19) United States
(12) Patent Application Publication
(10) Pub. No.: US 2005/0168372 A1
(43) Pub. Date: Aug. 4, 2005

(54) Method of activating a remotely controllable device

(76) Inventor: Gerrit Hollemans, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/503,246

(22) PCT Filed: Jan. 24, 2003
(86) PCT No.: PCT/IB03/00220

(30) Foreign Application Priority Data
Feb. 5, 2002 (EP) 02075474.3

(51) Int. Cl. G08C 19/12

(52) U.S. Cl. 341/176; 348/734; 340/825.69

(57) ABSTRACT

The invention relates to a system for remote control of a controllable device. The system comprises a remote control (101) unit with a means (103) for communicating at least one command produced by the remote control unit to the controllable device (102). The remote control unit (101) comprises at least one detector (104) for sensing the picking up of said remote control unit (101) or the proximity of a user. According to the invention, the remote control unit (101) is arranged to communicate an activating command (105) to the controllable device (102) upon obtaining an output from the detector (104) for sensing the picking up of said remote control unit or the proximity of a user. The system further comprises the controllable device (102) which is arranged to start booting upon receiving the activating command (105) from the remote control unit (101). The controllable device (102) may be a television set.

The invention relates to a system for remote control of a controllable device, the system comprising a remote control unit with a means for communicating at least one command produced by the remote control unit to the controllable device, the remote control unit comprising at least one detector for sensing the picking up of said remote control unit or the proximity of a user.

The invention also relates to a method of remotely controlling a controllable device, the method comprising a step of communicating at least one command produced by a remote control unit to the controllable device, and a step of sensing the picking up of said remote control unit or the proximity of a user.

An embodiment of such a system is known from Research Disclosure 33283, “Energy-saving Remote Control Unit”.

Nowadays, many consumer electronic (CE) products like television sets, videocassette recorders (VCR) and other video equipment, some domestic appliances, etc. can be controlled with a remote control unit. A controllable device is activated by a “wake-up” command sent by the remote control unit. Typically, the “wake-up” command is produced when a user presses one of the key available at the remote control unit, which may be also equipped with a touch screen or the like. In many cases, the controllable device is not ready to be used immediately upon receiving the “wake-up” command. A first step of pressing the key or touching the screen and generating the “wake-up” command by the remote control unit usually requires several seconds. In the next step, the user has to wait some time until the controllable device is in the “ready-to-use” state.

Such a CE product may incorporate personal computers for controlling the operation of this CE product. The personal computer remains in the boot state for some time after a power supply switch of the device has been turned on. The device is not ready for use, because the user has to wait until a boot-strap program of the personal computer is executed. In the meantime, the user cannot use said CE product.

In another example, the CE products may incorporate video display devices or the like, requiring a “warm-up” time after the power supply switch of the device has been turned on. Such devices do not display anything for some time so that these CE products can neither be used during the first seconds or minutes.

In this way, the user can actually use his/her TV set, VCR or the like after several seconds, or tens of seconds, or some minutes. This waiting period during which the CE product is being prepared for use is annoying and undesirable.

Many techniques of optimizing the CE electronic products for reducing said initialization time are known in the prior art. Despite this the currently known CE products are being initialized within a relatively short time, but many users would prefer to reduce said initialization time or eliminate it completely. It is not considered in the prior art to optimize the above-described first step of pressing the key or touching the screen and generate the “wake-up” command by the remote control unit.

It is an object of the invention to provide a system for remote control of a controllable device of the kind defined in the opening paragraph, the system being arranged to decrease or eliminate the initialization time of preparing the system for use by anticipating when the user would like to use this system.

The object of the invention is realized in that the remote control unit is arranged to communicate an activating command to the controllable device upon obtaining an output from at least one detector for sensing the picking up of said remote control unit or the proximity of a user.

In a first example, the user usually starts operating the controllable device by picking up the remote control unit which has a relatively small size, and the detector senses this picking up. In another example, the detector senses the proximity of a user, e.g. when the user moves his/her hand, finger, etc. in close proximity to the remote control unit or when the user intentionally moves his/her hand, finger, etc. towards the remote control unit. Particularly, the detector can be arranged to sense a user's physical contact with the remote control unit, such as touching the unit, before it is touched, moving the unit, etc. The detector may be a motion sensor, a heat sensor, a touch sensor or the like, incorporated in the remote control unit. Upon obtaining the output from the detector, the remote control unit communicates the activating command to the controllable device Obviously, the activating command causes the controllable device to switch on.

An advantage of the present invention is that the user only has to pick up or bring his/her hand near the remote control unit, etc. to activate the controllable device. The user does not need to press the button or touch the touch screen of the remote control unit or the like to specify one or more commands including the activating command to be sent to the controllable device known in the prior art. Another advantage is that, according to the present invention, the controllable device is being activated faster than is known in the prior art because the activating command is produced faster by the remote control unit. The advantage of the present invention will be apparent, if the controllable device needs a relatively long time to prepare it for use. An example of such a controllable device is the television system incorporating the personal computer which starts booting upon receiving the activating command.

According to an embodiment of the present invention, the remote control unit further comprises a timer for measuring the period of time of not using the remote control unit and/or the controllable device. The timer is arranged to provide a timer measurement. Immediately after producing the activating signal, the timer starts counting a time of non-use (idle time). If another output from the detector is obtained prior to expiration of a pre-set period of time, the timer automatically resets itself to once again begin counting the time of non-use. The pre-set time may be entered and changed by the user. If no further output from the detector is obtained, no further key is pressed or no further user action is detected prior to expiration of a pre-set period of time, and the remote control unit communicates a further command to the controllable device to switch off said controllable device. Subsequently, the remote control unit is also switched off, for example, to save battery energy.

The system operates with a first and second pre-set period of time. The first pre-set period of time is limited to a relatively short period of time such as three, five, or ten seconds in order to prevent switching on the controllable device unintentionally, for example by accidentally moving the remote control unit. It is assumed that if the user picks up, or moves his/her hand near the remote control unit, etc. not by chance, by pressing the key of the remote control unit to select the TV program, “surfing the TV programs”, etc. is further detected within this short period of time after obtaining the output from the detector. If no output from the detector is obtained, no key is pressed or no user action is detected after communicating the activating command, and the controllable device is given the switch off command. If the time of starting up the controllable device after receiving the activating command by said device is longer than the first pre-set period of time, the start-up of the controllable device can be stopped or undone upon receiving the switch-off command by said controllable device.

The second pre-set period of time is longer than the broadcast time of a “regular” TV program, e.g. half an hour, or one, two, or more hours. The controllable device is switched off if the user's attention is not focused on it. This is determined if no output from the detector is obtained, no key is pressed or no user action is detected within said second pre-set period of time. This may be useful, for example, when the user watches the TV program for half an hour and his/her attention has been diverted by something different for a relatively long time like, 10, 15 minutes, etc.

The remote control unit may be built in another material object different from the controllable device. The material object may be an object surrounding the controllable device, like a chair in front of the television set or another piece of furniture sensing when the user uses it. In that way, the remote control unit may be a simple device and may be arranged to communicate only the activating command to the controllable device and give a command to switch off the controllable device.

In a further embodiment, the remote control unit comprises a plurality of identical or non-identical detectors. For example, the remote control unit may comprise a motion sensor, a touch sensor, a heat sensor or another detector for sensing the proximity of a user to the remote control unit, the control unit or any part or combination of them.

In a further embodiment, the remote control unit is arranged to communicate the activating command repeatedly to the controllable device upon obtaining the output from the detector for sensing the picking up of said remote control unit or the proximity of a user. When the user picks up, moves his/her hand near the remote control unit, etc., it may not be possible to transmit the activating command to the controllable device immediately. This may happen because the remote control unit is designed to operate with infrared signals and is not directed to the controllable device, or when the remote control unit may be initially too far away from the controllable device, etc. In this way, the activating command is communicated repeatedly after a substantially short period of time.

In a further embodiment, the remote control unit comprises a means for bi-directional communication with the controllable device, and the controllable device comprises a means for bi-directional communication with the remote control unit. Such communication means are known in the prior art as various transceivers which are capable of receiving and transmitting signals.

In a further embodiment, the controllable device is arranged to communicate at least one acknowledge signal to the remote control unit, said acknowledge signal comprising a confirmation of receiving the activating command. In this way, the remote control unit is arranged to communicate the activating command repeatedly, preferably for a finite period of time. Thus, the repeated transmission of the activating command is stopped upon receiving the acknowledge signal from the controllable device.

In a further embodiment, the remote control unit comprises a plurality of means for communicating at least one command to the controllable device. This at least one command is communicated in more than one spatial direction. In this way, it will be possible to transmit the activating command to the controllable device, for example if the remote control unit is not directed to the controllable device and designed to operate with infrared signals. For example, the remote control unit may incorporate two of said communication means at the front and rear sides of its frame. Of course, many variations are possible, and the quantity of communication means necessary for transmitting the activating command depends on a construction and other factors related with the implementation of said communication means.

In a further embodiment, the means of the remote control unit for communication to the controllable device are designed to operate with RF signals. In some situations, the use of the remote control unit including the communication means designed to operate with RF signals is preferable because the RF signals are transmitted in all directions, the controllable device is installed at a location out of reach of R beams or the like.

The object of the present invention is also realized in that the method of the invention comprises a step of communicating an activating command to the controllable device upon obtaining an output from at least one detector for sensing the picking up of said remote control unit or the proximity of user. The method comprises the steps of operation of the system of the present invention.

These and other aspects of the present invention will be further elucidated and described with reference to the accompanying drawings, wherein:

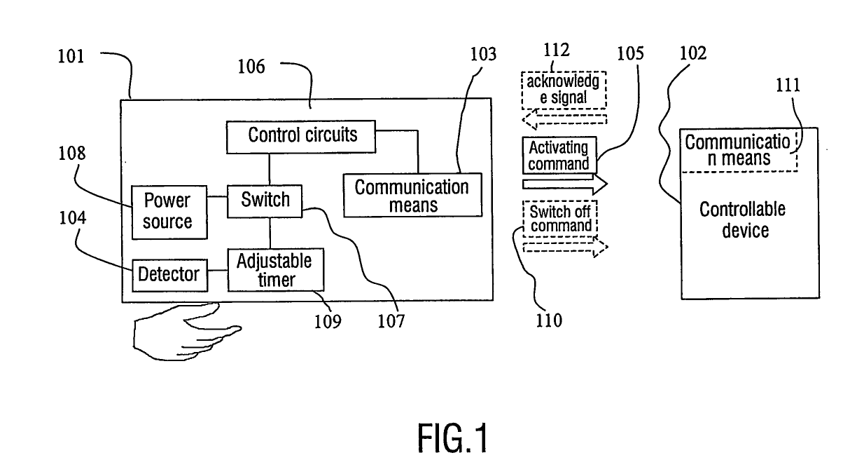

FIG. 1 shows a functional block diagram of the system of the present invention;

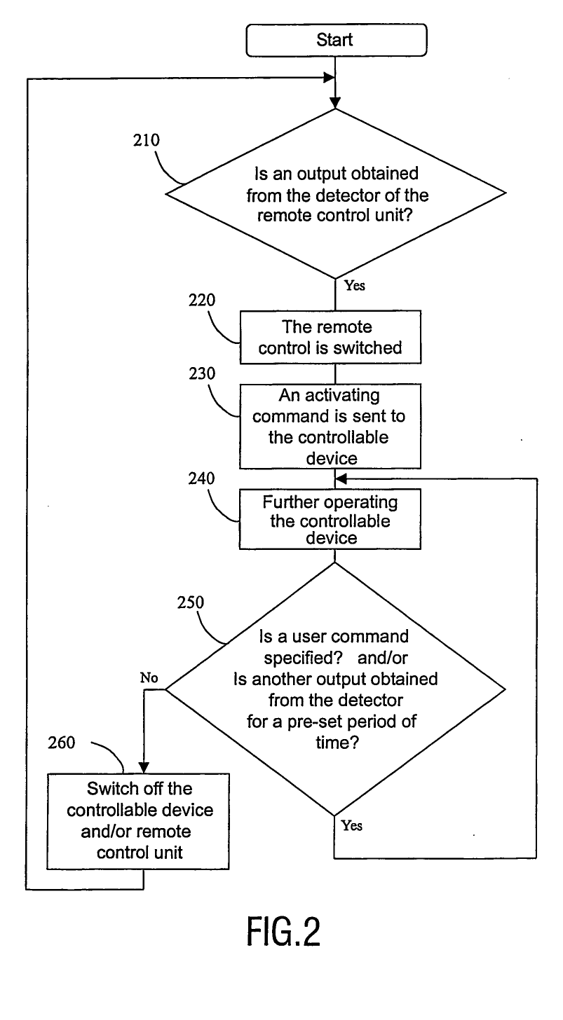

FIG. 2 shows a flow chart of the method of the present invention.

Referring to the drawings, FIG. 1 shows a functional block diagram of the system of the present invention.

The system includes a remote control unit 101 and a controllable device 102. The remote control unit 101 comprises a communication means 103 for communicating at least one command to the controllable device 102 and at least one detector 104 for sensing the picking up of said remote control unit 101 or the proximity of a user. The remote control unit 101 is arranged to communicate an activating command 105 to the controllable device 102 upon obtaining an output from the detector 104 for sensing the picking up of said remote control unit 101 or the proximity of a user's hand, finger, etc. to the remote control unit. Obviously, the activating command 105 causes the controllable device to switch on.

In a first example, the user usually starts operating the controllable device 102 by picking up the remote control unit 101 which has a relatively small size, and the detector 104 senses this picking up. In another example, the detector 104 senses the proximity of a user, e.g. when the user moves his/her hand, finger, etc. in close proximity to the remote control unit 101 or when the user intentionally moves his/her hand, finger, etc. towards the remote control unit 101. Particularly, the detector can be arranged to sense a user's physical contact with the remote control unit 101, such as touching the unit, before it is touched, moving the unit, etc. The detector 104 may be a motion sensor, a heat sensor, a touch sensor or the like, incorporated in the remote control unit 101.

The remote control unit 101 also comprises control circuits 106 coupled to the communication means 103 and a switch 107, which is coupled to a power source 108, and an adjustable timer 109. The control circuits 106 may be conventional remote control circuits known in the prior art. The remote control unit may have a plurality of keys such as numerical keys, function keys, which are widely known in the prior art.

The switch 107 and the adjustable timer 109 are controlled by the output of the detector 104 as known from document U.S. Pat. No. 6,259,486. The control circuits 106 and the communication means 103 receive power when the output is obtained from the detector 104. This significantly reduces the consumption of power from the power source 108 of the remote control unit 101. The timer 109 is designed to measure the period of time when the remote control unit 101 and/or the controllable device 102 is not used (or is idle). The timer 109 is arranged to provide a timer measurement. Immediately after producing the activating signal 105, the timer starts counting a time of non-use (or idle time). If another output from the detector 104 is obtained prior to expiration of a pre-set period of time, the timer automatically resets itself to once again begin counting the time of non-use. The timer will be also reset if the user presses one of the keys of the remote control unit or the like. The pre-set time may be entered and changed by the user. If no output from the detector 104 is obtained, no further key is pressed or no further user action is detected prior to expiration of a pre-set period of time, and the communication means 103 transmits a further command 110 to the controllable device 102 to switch off said controllable device 102. Subsequently, the remote control unit 101 is also switched off to save power provided by the power source 108.

The described system of the present invention allows cost-effective implementations. The controllable devices may include televisions, VCRs or other consumer electronic products requiring a relatively long time for booting or starting up and being capable of remotely receiving and executing the commands produced by the remote control unit. The remote control unit and controllable device can be arranged to communicate with each other via infrared signals.

The detector 104 may comprise a plurality of identical or non-identical detectors. For example, it may comprise more than one detector such as a motion sensor, a touch sensor, a heat sensor or another detector for sensing the proximity of a user to the remote control unit, the control unit, or any combination of them.

In an embodiment of the present invention, the remote control unit comprises the communication means 103 arranged for bi-directional communication with the controllable device, and the controllable device comprises a communication means 111 arranged for bi-directional communication with the remote control unit. Such communication means are known in the prior art as various transceivers which are capable of receiving and transmitting signals.

In a further embodiment, the controllable device 102 is arranged to communicate at least one acknowledge signal 112 to the remote control unit 101, said acknowledge signal comprising a confirmation of receiving the activating command 105. The remote control unit is arranged to communicate the activating command repeatedly, preferably for a finite period of time. Thus, the repeated transmission of the activating command is stopped upon receiving the acknowledge signal from the controllable device.

The method describes steps of operation of the system of the present invention. The method comprises a step of communicating the activating command to the controllable device upon obtaining the output from the detector for sensing the picking up of said remote control unit or the proximity of a user to the remote control unit.

Referring now to FIG. 2, a flow chart of the method of the present invention is shown. In step 210, it is verified whether the output is obtained from the detector for sensing the picking up of said remote control unit or the proximity of a user. If said output is obtained, the remote control unit is switched on upon obtaining said output from the detector in the next step 220, e.g. the communication means and the rest of the remote control unit receives power from the power source. Subsequently, the activating command is being sent to the controllable device in step 230.

Any other step known in the prior art may be performed with the controllable device in step 240. In this way, this step may comprise selecting TV channels, watching TV programs etc, in the case when the controllable device is the television set.

The method further comprises a step 250 of verifying whether any output is obtained from the detector of the remote control unit, or any button, key, etc. is pressed, or any other user action is performed with the remote control unit for the pre-set period of time. Step 250 may also comprise verifying whether the user's attention is focused on the remote control unit or controllable device. Step 250 is being performed according to the system of the present invention described above.

Step 260 is performed if no output is obtained from the detector of the remote control unit and/or no key is pressed, etc. in step 250. The remote control communicates the command to the controllable device to switch off said controllable device, and the remote control device is also switched off in step 260. Step 210 is further executed after step 260.

The object of the invention is achieved in that the system, method and various embodiments are provided with reference to the accompanying drawings. The system allows the user to start operating said system faster than is known in the prior art. The system is more user-friendly oriented. The advantages of the system are apparent when, for example, the controllable device is a device that cannot execute user commands immediately after receiving the activating command by said device, the device requiring some “warming up”, etc. Thus, the faster the activating command is sent to such a controllable device, the sooner the controllable device is ready to the further use.

The various program products may implement the functions of the system and method of the present invention and may be combined in several ways with the hardware or located in different devices. Variations and modifications of the described embodiment are possible within the scope of the inventive concept.

1. A system for remote control of a controllable device, the system comprising a remote control (101) unit with a means (103) for communicating at least one command produced by the remote control unit to the controllable device (102), the remote control unit (101) comprising at least one detector (104) for sensing the picking up of said remote control unit (101) or the proximity of a user, the system being characterized in that
the remote control unit (101) is arranged to communicate an activating command (105) to the controllable device (102) upon obtaining an output from the detector (104) for sensing the picking up of said remote control unit or the proximity of a user.

2. A system as claimed in claim 1, wherein the controllable device (102) is arranged to start booting upon receiving the activating command (105) from the remote control unit (101).

3. A system as claimed in claim 1, wherein the controllable device (102) is a television set.

4. A system as claimed in claim 1, wherein the remote control unit (101) comprises a timer (109) for measuring the period of time of not using the remote control unit (101) and/or the controllable device (101), the timer (109) being arranged to thereby provide a timer measurement,
the remote control unit (101) being arranged to communicate a further command (110) to the controllable device (102) to switch off said remote control unit (101) and/or controllable device (102) upon reaching a timer measurement equal to a pre-set period of time.

5. A system as claimed in claim 1, wherein the remote control unit (101) is arranged to communicate the activating command (105) repeatedly to the controllable device (102) upon obtaining the output from the detector (104) for sensing the picking up of said remote control unit or the proximity of a user.

6. A system as claimed in claim 1, wherein the remote control unit (101) comprises a means (103) for bi-directional communication with the controllable device (102), the controllable device (102) comprising a means (111) for bi-directional communication with the remote control unit (101).

7. A system as claimed in claim 6, wherein the controllable device (102) is arranged to communicate at least one acknowledge signal (112) to the remote control unit (101), said acknowledge signal (112) comprising a confirmation of receiving the activating command (105).

8. A system as claimed in claim 1, wherein the remote control unit (101) comprises a plurality of means for communicating at least one command produced by the remote control unit to the controllable device (102), said at least one command being communicated in more than one spatial direction.

9. A system as claimed in claim 1, wherein the means (103) of the remote control unit (101) for communication to the controllable device (102) are designed to operate with RF signals.

10. A method of remotelye controlling a controllable device, the method comprising a step of communicating at least one command produced by a remote control unit to the controllable device, and a step (210) of sensing the picking up of said remote control unit or the proximity of a user, the method being characterized in that the method comprises
a step (230) of communicating an activating command to the controllable device upon obtaining an output from at least one detector for sensing the picking up of said remote control unit or the proximity of a user.

11. A remote control unit for use in the system as claimed in claim 1, the remote control unit (101) comprising at least one detector (104) for sensing the picking up of said remote control unit (101) or the proximity of a user, the remote control unit (101) being arranged to communicate an activating command (105) to the controllable device (102) upon obtaining an output from the detector (104) for sensing the picking up of said remote control unit (101) or the proximity of a user.
